(19) United States
(12) Patent Application Publication
(10) Pub. No.: US 2024/0354169 A1
(43) Pub. Date: Oct. 24, 2024

(54) SYSTEM AND METHOD FOR DYNAMIC RESOURCE MANAGEMENT AND ALLOCATION FOR CLUSTER NETWORKS

(71) Applicant: RAKUTEN MOBILE, INC., Tokyo (JP)

(72) Inventors: Krishnakumar Gopalan KESAVAN, San Mateo, CA (US); Yash SHARMA, Indore (IN); Somya KUKREJA, Indore (IN)

(73) Assignee: RAKUTEN MOBILE, INC., Tokyo (JP)

(21) Appl. No.: 18/016,747

(22) PCT Filed: Dec. 20, 2022
(86) PCT No.: PCT/US2022/053494

§ 371 Date: Jan. 18, 2023

(30) Foreign Application Priority Data
Nov. 7, 2022 (IN) 202241063423

(51) Int. Cl. G06F 9/50

(52) U.S. Cl. CPC G06F 9/5083

(57) ABSTRACT

Embodiments herein provide a method and system of dynamically managing and allocating resources within a server cluster network. The method can include determining one or more operational requirements with respect to a first task and identifying a plurality of nodes within the server cluster network with respect to meeting the one or more operational requirements of the first task. The method can further include obtaining a traffic pattern with respect to each of the plurality of nodes with respect to one or more second tasks, and identifying a first node from the plurality of nodes for executing the first task. In addition, the method may include mapping the traffic patterns to a power requirement with respect to each of the plurality of nodes within the server cluster network. Further, the method may include generating a neural network model based on the mapped traffic patterns to power requirements.

### FIELD OF INVENTION

The present disclosure described herein relates to a method and system for a dynamic resource management and allocation for cluster networks.

### BACKGROUND

Computer or server clusters are generally a set of individual computing devices or servers (nodes) that work together and can be viewed as a single system. Clusters are usually deployed to improve performance, system scalability, and availability over that of a single computer or single server or node. There has been an increase in demand for clustered servers and nodes that enable processing to be continued without stopping in the event of an error, which improves processing performance, redundancy, and ensures that an entire network does not shut down. In such cluster systems, it is important to efficiently manage the distribution of the load on the cluster and how applications/tasks are to be distributed among the respective nodes of the cluster.

With the increased use of server clusters, there is a need for network operators to improve and optimize energy efficiency and minimize power consumption. Current solutions to improve efficiency is to either use the first-fit or best-fit algorithms in order to place an incoming application on a target cluster or node. For example, one conventional method is to place the incoming application, task, job, operation, or program on the first available cluster and node that matches the resource requirements of the incoming application. However, the drawback of the first available method is that energy efficiency is not optimized if a resource hungry cluster or node is utilized.

Hence, what is needed is a more efficient method and system for predicting and identifying clusters and servers/nodes that are best suited to execute and run a particular application, task, or job in order to better allocate network resources and improve energy savings and efficiency within a cluster network system. Thus, it is desired to address the above-mentioned disadvantages or other shortcomings or at least provide a useful alternative.

### OBJECT OF INVENTION

The principal object of the embodiments herein is to provide a system and method for dynamic resource management and allocation for cluster networks.

### SUMMARY

According to example embodiments, a method and system is disclosed for predicting and identifying clusters and servers/nodes that are best suited to execute and run a particular application, task, job, operation, or program in order to better allocate network resources and improve energy savings and efficiency within a cluster network system. Here, a new application to be run or executed typically has resource requirements for a host or target cluster, server/node, or computing system, such as the number of virtual cores needed, the amount of RAM memory needed, the amount of storage disk space, and in addition other requirements, such as access to field-programmable gate arrays (FPGA). In some embodiments, the method and system of the disclosure described herein can employ a pre-built artificial intelligence (“AI”), machine learning (“ML”), or neural network (“NN”) model to recommend an optimal server/node for the new application to be executed on a cluster. Here, The ML/NN model can be built with the objective of minimizing the energy consumption of the entire cluster or that of a specific server/node.

In other embodiments, a method of allocating resources within a server cluster network is disclosed. The method can include determining one or more operational requirements with respect to a first task; identifying a plurality of nodes within the server cluster network with respect to meeting the one or more operational requirements of the first task; obtaining a traffic pattern with respect to each of the plurality of nodes with respect to one or more second tasks; and identifying a first node from the plurality of nodes for executing the first task.

The method may further include wherein the first task includes is at least one of an application, program, job, or operation.

In addition, the method may include mapping the traffic patterns to a power requirement with respect to each of the plurality of nodes within the server cluster network.

Further, the method may include generating a neural network model based on the mapped traffic patterns to power requirements with respect to each of the plurality of nodes within the server cluster network.

Also, the neural network model may be based on embeddings.

In addition, the step of identifying the first node from the plurality of nodes for executing the first task may be based on the generated neural network model.

Further, the step of identifying the first node from the plurality of nodes for executing the first task may be further based on predicting future power consumption by each of the plurality of nodes.

Moreover, the method may include assigning the first task to the identified first node.

Also, the method may include determining one or more operational requirements with respect to a third task; and identifying a second node from the plurality of nodes for executing the third task.

In addition, the method may include wherein the step of identifying the first node from the plurality of nodes for executing the first task is based on a neural network model.

In other embodiments, an apparatus for allocating resources within a server cluster network is disclosed, the apparatus including a memory storage storing computer-executable instructions; and a processor communicatively coupled to the memory storage, wherein the processor is configured to execute the computer-executable instructions and cause the apparatus to determine one or more operational requirements with respect to a first task; identify a plurality of nodes within the server cluster network with respect to meeting the one or more operational requirements of the first task; obtain a traffic pattern with respect to each of the plurality of nodes with respect to one or more second tasks; and identify a first node from the plurality of nodes for executing the first task.

In addition, the first task may include at least one of: an application, program, job, or operation.

Also, the computer-executable instructions, when executed by the processor, may further cause the apparatus to map the traffic patterns to power requirements with respect to each of the plurality of nodes within the server cluster network.

Moreover, the computer-executable instructions, when executed by the processor, may further cause the apparatus to generate a neural network model based on the mapped traffic patterns to power requirement with respect to each of the plurality of nodes within the server cluster network.

Further, the neural network model may be based on embeddings.

In addition, the step of identifying the first node from the plurality of nodes for executing the first task may be based on the generated neural network model.

Also, the step of identifying the first node from the plurality of nodes for executing the first task may further be based on predicting future power consumption by each of the plurality of nodes.

Moreover, the computer-executable instructions, when executed by the processor, may further cause the apparatus to assign the first task to the identified first node.

In addition, the computer-executable instructions, when executed by the processor, may further cause the apparatus to determine one or more operational requirements with respect to a third task; and identify a second node from the plurality of nodes for executing the third task.

In other embodiments, a non-transitory computer-readable medium having computer-executable instructions for allocating resources within a server cluster network by an apparatus, wherein the computer-executable instructions, when executed by at least one processor of the apparatus, cause the apparatus to determine one or more operational requirements with respect to a first task; identify a plurality of nodes within the server cluster network with respect to meeting the one or more operational requirements of the first task; obtain a traffic pattern with respect to each of the one or more nodes with respect to one or more second tasks; and identify a first node from the plurality of nodes for executing the first task.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This method is illustrated in the accompanying drawings, throughout which like reference letters indicate corresponding parts in the various figures. The embodiments herein will be better understood from the following description with reference to the drawings, in which:

FIG. 1 illustrates a diagram of a general system architecture of the dynamic resource management and allocation method and system of the disclosure described herein according to one or more exemplary embodiments;

FIG. 2 illustrates another diagram of components and modules for the dynamic resource management and allocation method and system of the disclosure described herein according to one or more exemplary embodiments;

FIG. 3 illustrates another diagram for a method of operation for the dynamic resource management and allocation method and system of the disclosure described herein according to one or more exemplary embodiments; and

FIG. 4 illustrates a graph diagram for at least one metric for the dynamic resource management and allocation method and system of the disclosure described herein according to one or more exemplary embodiments.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

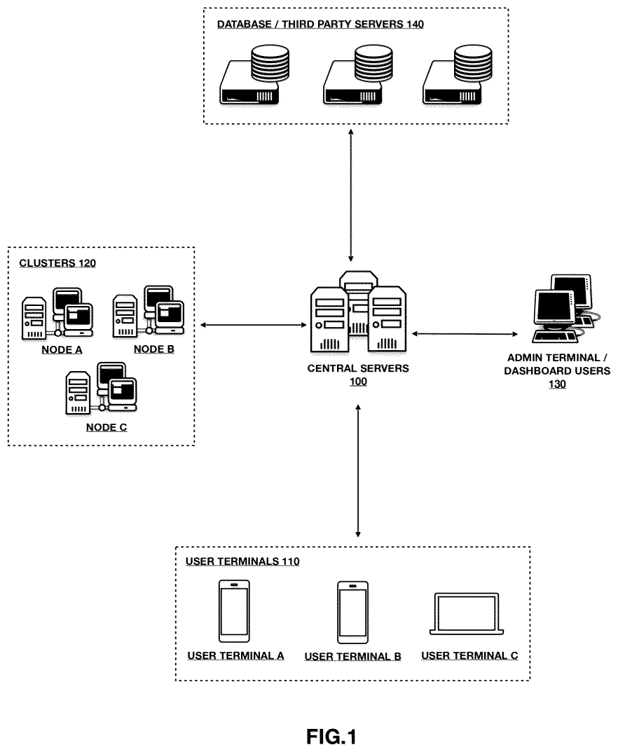

FIG. 1 illustrates a diagram of a general network architecture according to one or more embodiments. Referring to FIG. 1, user terminals 110, clusters 120, and admin terminal/dashboard users 130 can be in bi-directional communication over a secure network with central servers or application servers 100 according to one or more embodiments. In addition, components 110, 120, 130 may also be in direct bi-directional communication with each other via the network system of the disclosure described herein according to one or more embodiments. Here, user terminals 110 can be any type of user device or user equipment (UE) and customer of a network or telecommunication service provider, such as users operating computing user terminals A, B, and C. Each of user terminal 110 can communicate with servers 100 via their respective terminals or portals. Clusters 120 can include any type number of network clusters, server clusters, and number of individual server nodes A, B, and C for executing or running any type of application, software, job, queue, task, or operation within the network. Here, any of clusters 120 and nodes A, B, and C can be target clusters or target nodes for executing and running any application, task, job, or program. Admin terminal or dashboard 130 may include any type of user with access privileges for accessing a dashboard or management portal of the disclosure described herein, wherein the dashboard portal can provide various user tools, maps, resource allocation, energy orchestration, and customer support options. It is contemplated within the scope of the present disclosure described herein that any user of user terminals 110 may also access the admin terminal or dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors and databases where various captured, collected, or aggregated data from clusters 120 (including its nodes) and/or user terminals 110 may be uploaded thereto or stored thereon and retrieved therefrom for network analysis and neural network (NN), machine learning (ML), and artificial intelligence (AI) processing and modeling by servers 100. However, it is contemplated within the scope of the present disclosure described herein that the dynamic resource management and allocation method and system of the disclosure described herein can include any type of general network architecture.

Still referring to FIG. 1, one or more of servers or terminals of elements 100-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-140. For example, the bus may be a communication bus, a cross-over bar, a network, or the like. The bus may be implemented using single or multiple (two or more) connections between the set of components of one or more of servers or terminals of elements 100-140. The disclosure is not limited in this regard.

One or more of servers or terminals of elements 100-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-140 and/or of the set of components of one or more of servers or terminals of elements 100-140 (e.g., memory, storage component, input component, output component, communication interface, rendering component).

One or more of servers or terminals of elements 100-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-140 may store information and/or computer-readable instructions and/or code related to the operation and use of one or more of servers or terminals of elements 100-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-140 may further comprise an input component. The input component may include one or more components that permit one or more of servers and terminals 100-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-140 may further comprise a communication interface. The communication interface may include a receiver component, a transmitter component, and/or a transceiver component. The communication interface may enable one or more of servers or terminals of elements 100-140 to establish connections and/or transfer communications with other devices (e.g., a server, another device). The communications may be enabled via a wired connection, a wireless connection, or a combination of wired and wireless connections. The communication interface may permit one or more of servers or terminals of elements 100-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like. In the embodiments, any one of the operations or processes of the figures may be implemented by or using any one of the elements disclosed herein. It is understood that other embodiments are not limited thereto, and may be implemented in a variety of different architectures (e.g., bare metal architecture, any cloud-based architecture or deployment architecture such as Kubernetes, Docker, OpenStack, etc.)

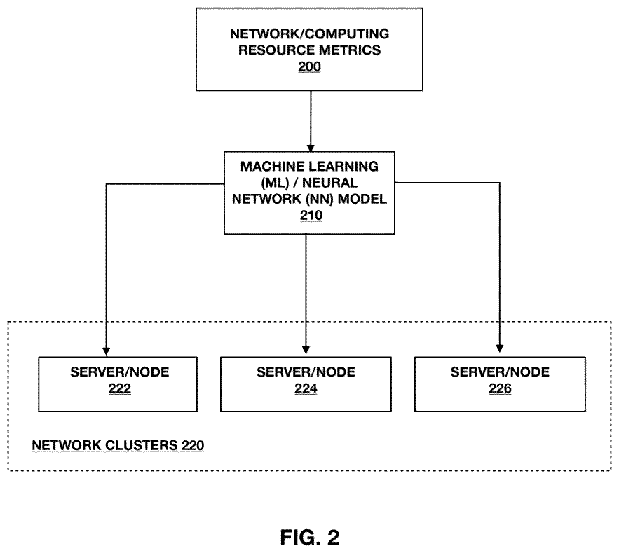

FIG. 2 illustrates a diagram of various components and modules for one exemplary embodiment of the disclosure described herein. Here, the dynamic resource management and allocation method and system of the disclosure described herein can include a network/computing resource metrics module 200, a machine learning (“ML”)/neural network (“NN”) model 210, and network clusters module 220 having multiple servers/nodes, such as servers/nodes 222, 224, and 226. Here, the network/computing resources metrics module 200 can include various metrics that can be taken into consideration and used as input within the ML/NN model module 210 of the disclosure described herein. Such metrics are determined or identified from the source or incoming application/task needing to be executed or run on a target server/node within a cluster, or alternatively, the ML/NN model can identify and determine the best metrics to be used by the model (or use certain thresholds/conditions to filter for the most suitable metrics). Here, each individual metric can pertain to power consumption, energy requirements, energy efficiency, processing speed, usage, availability, retrieval/storage, storage space, programmability, protocol, hardware/software compatibility, bandwidth, thresholds/conditions, and/or various operational requirements. For example, such metrics can include but not limited to, CPU, CEPH (e.g., software defined storage platform), Inodes (e.g., data structures), Disk I/O (e.g., disk input/output operations), Docker (e.g., platform as a service), Memstats (e.g., memory status/statistics), kernel (e.g., OS kernel), system load, swap (e.g., swap memory), processes, UDP (e.g., User Datagram Protocol), TCP/IP, ICMP (e.g., Internet Control Message Protocol), malloc (e.g., memory allocation), airflow, heat, FPGA (e.g., Field Programmable Gate Arrays), fan speed, power, voltage, LED, file DES (e.g., file descriptors), open stack, message queue, HAproxy (e.g., reverse-proxy), HTTP, large pages/webpages, context switching, interrupt, balloon, network, watchdog, threads (e.g., processing threads), Prometheus (e.g., monitoring systems), and users, among others.

The following TABLES 1-11 illustrate additional exemplary metrics that may be used or determined by the ML/NN model module 210 of the disclosure described herein.

TABLE 1

kernel_context_switches
kernel_boot_time
kernel_interrupts
kernel_processes_forked
kernel_entropy_avail
process_resident_memory_bytes
process_cpu_seconds_total
process_start_time_seconds
process_max_fds
process_virtual_memory_bytes
process_virtual_memory_max_bytes
process_open_fds
ceph_usage_total_used
ceph_usage_total_space
ceph_usage_total_avail
ceph_pool_usage_objects
ceph_pool_usage_kb_used
ceph_pool_usage_bytes_used
ceph_pool_stats_write_bytes_sec
ceph_pool_stats_recovering_objects_per_sec
ceph_pool_stats_recovering_keys_per_sec
ceph_pool_stats_recovering_bytes_per_sec
ceph_pool_stats_read_bytes_sec
ceph_pool_stats_op_per_sec
ceph_pgmap_write_bytes_sec
ceph_pgmap_version
ceph_pgmap_state_count
ceph_pgmap_read_bytes_sec
ceph_pgmap_op_per_sec
ceph_pgmap_num_pgs
ceph_pgmap_data_bytes
ceph_pgmap_bytes_used
ceph_pgmap_bytes_total
ceph_pgmap_bytes_avail
ceph_osdmap_num_up_osds
ceph_osdmap_num_remapped_pgs
ceph_osdmap_num_osds
ceph_osdmap_num_in_osds
ceph_osdmap_epoch
ceph_health
ceph_pool_stats_write_op_per_sec
ceph_pgmap_write_op_per_sec
ceph_pool_stats_read_op_per_sec
ceph_pgmap_read_op_per_sec
conntrack_ip_conntrack_max
conntrack_ip_conntrack_count
go_memstats_mcache_sys_bytes
go_memstats_buck_hash_sys_bytes
go_memstats_stack_sys_bytes
go_memstats_heap_objects
go_gc_duration_seconds_sum
go_memstats_heap_idle_bytes
go_memstats_heap_released_bytes_total

TABLE 2

go_memstats_other_sys_bytes
go_memstats_heap_sys_bytes
go_memstats_mcache_inuse_bytes
go_memstats_mspan_inuse_bytes
go_memstats_heap_inuse_bytes
go_memstats_stack_inuse_bytes
go_gc_duration_seconds
go_memstats_alloc_bytes
go_gc_duration_seconds_count
go_memstats_alloc_bytes_total
go_memstats_sys_bytes
go_memstats_heap_released_bytes
go_memstats_gc_cpu_fraction
go_memstats_gc_sys_bytes
go_memstats_mallocs_total
go_memstats_mspan_sys_bytes
go_memstats_lookups_total
go_memstats_next_gc_bytes
go_threads
go_memstats_last_gc_time_seconds
go_memstats_frees_total
go_goroutines
go_info
go_memstats_heap_alloc_bytes
cp_hypervisor_memory_mb_used
cp_hypervisor_running_vms
cp_hypervisor_up
cp_openstack_service_up
cp_hypervisor_memory_mb
cp_hypervisor_vcpus
cp_hypervisor_vcpus_used
disk_inodes_used
disk_total
disk_inodes_total
disk_free
disk_inodes_free
disk_used_percent
disk_used
ntpq_offset
ntpq_reach
ntpq_delay
ntpq_when
ntpq_jitter
ntpq_poll
system_load15
system_n_cpus
system_uptime
system_n_users
system_load5
system_load1
scrape_samples_scraped
scrape_samples_post_metric_relabeling
scrape_duration_seconds
internal_memstats_heap_objects

TABLE 3

internal_memstats_mallocs
internal_write_metrics_added
internal_write_write_time_ns
internal_memstats_heap_idle_bytes
internal_agent_metrics_written
internal_agent_metrics_gathered
internal_memstats_heap_in_use_bytes
internal_memstats_heap_sys_bytes
internal_memstats_heap_released_bytes
internal_gather_gather_time_ns
internal_write_buffer_limit
internal_agent_gather_errors
internal_memstats_frees
internal_agent_metrics_dropped
internal_write_metrics_dropped
internal_memstats_num_gc
internal_write_buffer_size
internal_gather_metrics_gathered
internal_memstats_alloc_bytes
internal_write_metrics_written
internal_write_metrics_filtered
internal_memstats_sys_bytes
internal_memstats_total_alloc_bytes
internal_memstats_pointer_lookups
internal_memstats_heap_alloc_bytes
diskio_iops_in_progress
diskio_io_time
diskio_read_time
diskio_writes
diskio_weighted_io_time
diskio_write_time
diskio_reads
diskio_write_bytes
diskio_read_bytes
net_icmpmsg_intype3
net_icmp_inaddrmaskreps
net_icmpmsg_intype0
net_tcp_rtoalgorithm
net_icmpmsg_intype8
net_packets_sent
net_udplite_inerrors
net_udplite_sndbuferrors
net_conntrack_dialer_conn_closed_total
net_top_estabresets
net_icmp_indestunreachs
net_icmp_outaddrmasks
net_err_out
net_icmp_intimestamps
net_icmp_inerrors
net_ip_fragfails
net_ip_outrequests
net_udplite_rcvbuferrors
net_ip_inaddrerrors

TABLE 4

net_tcp_insegs
net_tcp_incsumerrors
net_icmpmsg_outtype0
net_icmpmsg_outtype3
net_icmpmsg_outtype8
net_icmp_intimestampreps
net_tcp_outsegs
net_ip_fragcreates
net_tcp_retranssegs
net_icmp_inechoreps
net_udplite_indatagrams
net_icmp_outtimestamps
net_ip_reasmoks
net_tcp_attemptfails
net_icmp_inmsgs
net_ip_reasmfails
net_ip_indelivers
net_icmp_intimeexcds
net_icmp_outredirects
net_ip_defaultttl
net_icmp_outtimeexcds
net_icmp_outechos
net_ip_forwarding
net_icmp_inechos
net_ip_indiscards
net_ip_reasmtimeout
net_udp_indatagrams
net_bytes_recv
net_icmp_outerrors
net_conntrack_listener_conn_accepted_total
net_icmp_inaddrmasks
net_err_in
net_tcp_passiveopens
net_icmp_outaddrmaskreps
net_udplite_incsumerrors
net_udp_noports
net_tcp_outrsts
net_drop_out
net_conntrack_dialer_conn_attempted_total
net_icmp_inparmprobs
net_icmp_insrcquenchs
net_drop_in
net_icmp_outtimestampreps
net_ip_inreceives
net_udplite_outdatagrams
net_ip_forwdatagrams
net_conntrack_listener_conn_closed_total
net_icmp_outsrcquenchs
net_icmp_outechoreps
net_tcp_rtomax
net_udp_rcvbuferrors
net_conntrack_dialer_conn_established_total
net_tcp_activeopens
net_ip_outnoroutes
net_tcp_currestab

TABLE 5

net_ip_outdiscards
net_tcp_maxconn
net_udp_inerrors
net_tcp_rtomin
net_icmp_inredirects
net_icmp_outmsgs
net_icmp_outparmprobs
net_ip_reasmreqds
net_ip_inunknownprotos
net_udplite_noports
net_icmp_incsumerrors
net_ip_inhdrerrors
net_udp_incsumerrors
net_packets_recv
net_conntrack_dialer_conn_failed_total
net_bytes_sent
net_udp_sndbuferrors
net_udp_outdatagrams
net_tcp_inerrs
net_ip_fragoks
net_icmp_outdestunreachs
swap_out
swap_used
swap_free
swap_total
swap_in
swap_used_percent
http_response_result_code
http_response_http_response_code
http_response_response_time
mem_available_percent
mem_huge_pages_total
mem_used
mem_total
mem_commit_limit
mem_available
mem_cached
mem_write_back
mem_dirty
mem_used_percent
mem_vmalloc_chunk
mem_page_tables
mem_high_free
mem_swap_free
mem_swap_total
mem_committed_as
mem_inactive
mem_low_total
mem_buffered
mem_huge_pages_free
mem_swap_cached
mem_vmalloc_total
mem_slab

TABLE 6

mem_vmalloc_used
mem_wired
mem_high_total
mem_shared
mem_free
mem_write_back_tmp
mem_mapped
mem_huge_page_size
mem_low_free
mem_active
ipmi_sensor
ipmi_sensor_status
linkstate_partner
linkstate_actor
linkstate_sriov
prometheus_sd_kubernetes_cache_short_watches_total
prometheus_engine_query_duration_seconds_count
prometheus_tsdb_reloads_total
prometheus_template_text_expansion_failures_total
prometheus_target_scrape_pool_sync_total
prometheus_rule_group_duration_seconds_sum
prometheus_tsdb_checkpoint_deletions_total
prometheus_sd_openstack_refresh_failures_total
prometheus_target_interval_length_seconds_sum
prometheus_sd_gce_refresh_duration_count
prometheus_tsdb_compaction_chunk_size_bytes_count
prometheus_notifications_sent_total
prometheus_sd_consul_rpc_duration_seconds_sum
prometheus_http_request_duration_seconds_bucket
prometheus_tsdb_compaction_duration_seconds_bucket
prometheus_sd_ec2_refresh_duration_seconds_count
prometheus_sd_kubernetes_cache_list_duration_seconds_sum
prometheus_sd_dns_lookups_total
prometheus_template_text_expansions_total
prometheus_sd_triton_refresh_duration_seconds_sum
prometheus_sd_ec2_refresh_failures_total
prometheus_rule_group_duration_seconds
prometheus_sd_triton_refresh_failures_total
prometheus_sd_kubernetes_cache_list_items_count
prometheus_sd_kubernetes_events_total
prometheus_sd_file_scan_duration_seconds
prometheus_tsdb_wal_truncate_duration_seconds_sum
prometheus_sd_dns_lookup_failures_total
prometheus_engine_query_duration_seconds_sum
prometheus_sd_openstack_refresh_duration_seconds
prometheus_tsdb_head_max_time_seconds
prometheus_rule_evaluation_duration_seconds
prometheus_tsdb_head_series_created_total
prometheus_tsdb_head_truncations_total
prometheus_tsdb_checkpoint_creations_total
prometheus_tsdb_head_gc_duration_seconds_sum
prometheus_tsdb_head_chunks_removed_total
prometheus_sd_azure_refresh_failures_total
prometheus_http_response_size_bytes_sum
prometheus_sd_triton_refresh_duration_seconds

TABLE 7
prometheus_tsdb_head_series_removed_total
prometheus_rule_group_interval_seconds
prometheus_notifications_latency_seconds_count
prometheus_http_request_duration_seconds_sum
prometheus_http_request_duration_seconds_count
prometheus_tsdb_tombstone_cleanup_seconds_count
prometheus_tsdb_compaction_chunk_range_seconds_sum
prometheus_tsdb_wal_fsync_duration_seconds
prometheus_target_sync_length_seconds_count
prometheus_sd_consul_rpc_duration_seconds_count
prometheus_tsdb_compaction_chunk_range_seconds_count
prometheus_sd_marathon_refresh_duration_seconds_sum
prometheus_tsdb_compactions_total
prometheus_target_sync_length_seconds
prometheus_tsdb_wal_fsync_duration_seconds_count
prometheus_sd_marathon_refresh_duration_seconds
prometheus_treecache_watcher_goroutines
prometheus_sd_updates_total
prometheus_tsdb_compaction_chunk_samples_bucket
prometheus_sd_openstack_refresh_duration_seconds_sum
prometheus_target_scrapes_sample_out_of_bounds_total
prometheus_tsdb_time_retentions_total
prometheus_notifications_queue_capacity
prometheus_tsdb_head_truncations_failed_total
prometheus_tsdb_wal_page_flushes_total
prometheus_sd_kubernetes_cache_list_items_sum
prometheus_sd_kubernetes_cache_last_resource_version
prometheus_http_response_size_bytes_bucket
prometheus_target_sync_length_seconds_sum
prometheus_tsdb_wal_corruptions_total
prometheus_notifications_alertmanagers_discovered
prometheus_rule_group_last_evaluation_timestamp_seconds
prometheus_sd_azure_refresh_duration_seconds
prometheus_sd_gce_refresh_duration
prometheus_notifications_latency_seconds_sum
prometheus_sd_gce_refresh_failures_total
prometheus_tsdb_compactions_triggered_total
prometheus_sd_azure_refresh_duration_seconds_count
prometheus_rule_evaluations_total
prometheus_rule_group_last_duration_seconds
prometheus_tsdb_wal_fsync_duration_seconds_sum
prometheus_target_interval_length_seconds
prometheus_tsdb_wal_completed_pages_total
prometheus_tsdb_head_max_time
prometheus_tsdb_checkpoint_creations_failed_total
prometheus_treecache_zookeeper_failures_total
prometheus_sd_marathon_refresh_failures_total
prometheus_tsdb_wal_truncations_total
prometheus_sd_openstack_refresh_duration_seconds_count
prometheus_tsdb_head_series_not_found_total
prometheus_tsdb_lowest_timestamp
prometheus_tsdb_compaction_chunk_size_bytes_bucket
prometheus_sd_kubernetes_cache_list_duration_seconds_count

TABLE 8
prometheus_tsdb_head_series_removed_total
prometheus_rule_group_interval_seconds
prometheus_notifications_latency_seconds_count
prometheus_http_request_duration_seconds_sum
prometheus_http_request_duration_seconds_count
prometheus_tsdb_tombstone_cleanup_seconds_count
prometheus_tsdb_compaction_chunk_range_seconds_sum
prometheus_tsdb_wal_fsync_duration_seconds
prometheus_target_sync_length_seconds_count
prometheus_sd_consul_rpc_duration_seconds_count
prometheus_tsdb_compaction_chunk_range_seconds_count
prometheus_sd_marathon_refresh_duration_seconds_sum
prometheus_tsdb_compactions_total
prometheus_target_sync_length_seconds
prometheus_tsdb_wal_fsync_duration_seconds_count
prometheus_sd_marathon_refresh_duration_seconds
prometheus_treecache_watcher_goroutines
prometheus_sd_updates_total
prometheus_tsdb_compaction_chunk_samples_bucket
prometheus_sd_openstack_refresh_duration_seconds_sum
prometheus_target_scrapes_sample_out_of_bounds_total
prometheus_tsdb_time_retentions_total
prometheus_notifications_queue_capacity
prometheus_tsdb_head_truncations_failed_total
prometheus_tsdb_wal_page_flushes_total
prometheus_sd_kubernetes_cache_list_items_sum
prometheus_sd_kubernetes_cache_last_resource_version
prometheus_http_response_size_bytes_bucket
prometheus_target_sync_length_seconds_sum
prometheus_tsdb_wal_corruptions_total
prometheus_notifications_alertmanagers_discovered
prometheus_rule_group_last_evaluation_timestamp_seconds
prometheus_sd_azure_refresh_duration_seconds
prometheus_sd_gce_refresh_duration
prometheus_notifications_latency_seconds_sum
prometheus_sd_gce_refresh_failures_total
prometheus_tsdb_compactions_triggered_total
prometheus_sd_azure_refresh_duration_seconds_count
prometheus_rule_evaluations_total
prometheus_rule_group_last_duration_seconds
prometheus_tsdb_wal_fsync_duration_seconds_sum
prometheus_target_interval_length_seconds
prometheus_tsdb_wal_completed_pages_total
prometheus_tsdb_head_max_time
prometheus_tsdb_checkpoint_creations_failed_total
prometheus_treecache_zookeeper_failures_total
prometheus_sd_marathon_refresh_failures_total
prometheus_tsdb_wal_truncations_total
prometheus_sd_openstack_refresh_duration_seconds_count
prometheus_tsdb_head_series_not_found_total
prometheus_tsdb_lowest_timestamp
prometheus_tsdb_compaction_chunk_size_bytes_bucket
prometheus_sd_kubernetes_cache_list_duration_seconds_count

TABLE 9
prometheus_tsdb_head_active_appenders
prometheus_tsdb_wal_truncations_failed_total
prometheus_tsdb_compactions_failed_total
prometheus_sd_kubernetes_cache_watch_events_count
prometheus_rule_evaluation_duration_seconds_sum
prometheus_tsdb_compaction_chunk_samples_sum
prometheus_sd_consul_rpc_failures_total
prometheus_tsdb_storage_blocks_bytes_total
prometheus_sd_kubernetes_cache_watches_total
prometheus_tsdb_checkpoint_deletions_failed_total
prometheus_sd_ec2_refresh_duration_seconds_sum
prometheus_rule_group_rules
prometheus_notifications_errors_total
prometheus_sd_file_scan_duration_seconds_count
prometheus_tsdb_head_min_time_seconds
prometheus_tsdb_compaction_duration_seconds_count
prometheus_rule_group_iterations_total
prometheus_sd_ec2_refresh_duration_seconds
prometheus_engine_queries_concurrent_max
prometheus_engine_queries
prometheus_tsdb_wal_truncate_duration_seconds
prometheus_engine_query_duration_seconds
prometheus_tsdb_lowest_timestamp_seconds
prometheus_notifications_dropped_total
prometheus_sd_kubernetes_cache_watch_duration_seconds_count
prometheus_tsdb_compaction_chunk_samples_count
prometheus_sd_consul_rpc_duration_seconds
prometheus_rule_evaluation_failures_total
prometheus_sd_file_read_errors_total
prometheus_tsdb_head_chunks_created_total
prometheus_rule_group_iterations_missed_total
prometheus_tsdb_head_min_time
prometheus_tsdb_tombstone_cleanup_seconds_sum
prometheus_rule_evaluation_duration_seconds_count
prometheus_target_scrapes_sample_out_of_order_total
prometheus_notifications_queue_length
prometheus_tsdb_blocks_loaded
prometheus_tsdb_head_gc_duration_seconds_count
prometheus_sd_kubernetes_cache_list_total
prometheus_sd_discovered_targets
prometheus_target_scrapes_sample_duplicate_timestamp_total
prometheus_config_last_reload_success_timestamp_seconds
prometheus_sd_marathon_refresh_duration_seconds_count
prometheus_sd_triton_refresh_duration_seconds_count
prometheus_http_response_size_bytes_count
prometheus_notifications_latency_seconds
prometheus_config_last_reload_successful
prometheus_tsdb_head_series
prometheus_tsdb_compaction_chunk_size_bytes_sum
prometheus_tsdb_head_samples_appended_total
prometheus_api_remote_read_queries
prometheus_sd_gce_refresh_duration_sum
prometheus_rule_group_duration_seconds_count
prometheus_sd_kubernetes_cache_watch_events_sum
prometheus_sd_file_scan_duration_seconds_sum

TABLE 10
prometheus_target_scrapes_exceeded_sample_limit_total
prometheus_tsdb_head_gc_duration_seconds
prometheus_build_info
prometheus_tsdb_compaction_duration_seconds_sum
prometheus_tsdb_size_retentions_total
prometheus_sd_azure_refresh_duration_seconds_sum
prometheus_tsdb_compaction_chunk_range_seconds_bucket
prometheus_tsdb_wal_truncate_duration_seconds_count
prometheus_target_interval_length_seconds_count
prometheus_tsdb_tombstone_cleanup_seconds_bucket
prometheus_tsdb_head_chunks
prometheus_sd_received_updates_total
prometheus_tsdb_reloads_failures_total
prometheus_tsdb_symbol_table_size_bytes
prometheus_sd_kubernetes_cache_watch_duration_seconds_sum
haproxy_req_rate_max
haproxy_chkdown
haproxy_wredis
haproxy_chkfail
haproxy_active_servers
haproxy_econ
haproxy_qmax
haproxy_check_code
haproxy_lastsess
haproxy_bin
haproxy_downtime
haproxy_http_response_1xx
haproxy_backup_servers
haproxy_req_rate
haproxy_req_tot
haproxy_http_response_4xx
haproxy_qcur
haproxy_iid
haproxy_weight
haproxy_smax
haproxy_rate_max
haproxy_hanafail
haproxy_srv_abort
haproxy_wretr
haproxy_lastchg
haproxy_eresp
haproxy_stot
haproxy_dresp
haproxy_sid
haproxy_qtime
haproxy_comp_rsp
haproxy_dreq
haproxy_rate_lim
haproxy_cli_abort
haproxy_scur
haproxy_http_response_5xx
haproxy_comp_in
haproxy_rate

TABLE 11

haproxy_ereq
haproxy_rtime
haproxy_lbtot
haproxy_ttime
haproxy_pid
haproxy_comp_out
haproxy_http_response_3xx
haproxy_ctime
haproxy_bout
haproxy_http_response_2xx
haproxy_slim
haproxy_check_duration
haproxy_http_response_other
haproxy_comp_byp
processes_sleeping
processes_paging
processes_unknown
processes_stopped
processes_total_threads
processes_running
processes_total
processes_zombies
processes_blocked
processes_idle
processes_dead
promhttp_metric_handler_requests_total
promhttp_metric_handler_requests_in_flight
up
hugepages_free
hugepages_surplus
hugepages_nr
docker_container_mem_usage
docker_container_mem_usage_percent
docker_container_status_finished_at
docker_n_containers_stopped
docker_container_status_exitcode
docker_container_cpu_usage_percent
docker_n_containers
docker_n_containers_paused
docker_n_containers_running
docker_container_status_started_at
cpu_usage_softirq
cpu_usage_guest
cpu_usage_guest_nice
cpu_usage_idle
cpu_usage_iowait
cpu_usage_steal
cpu_usage_nice
cpu_usage_user
cpu_usage_irq
cpu_usage_system

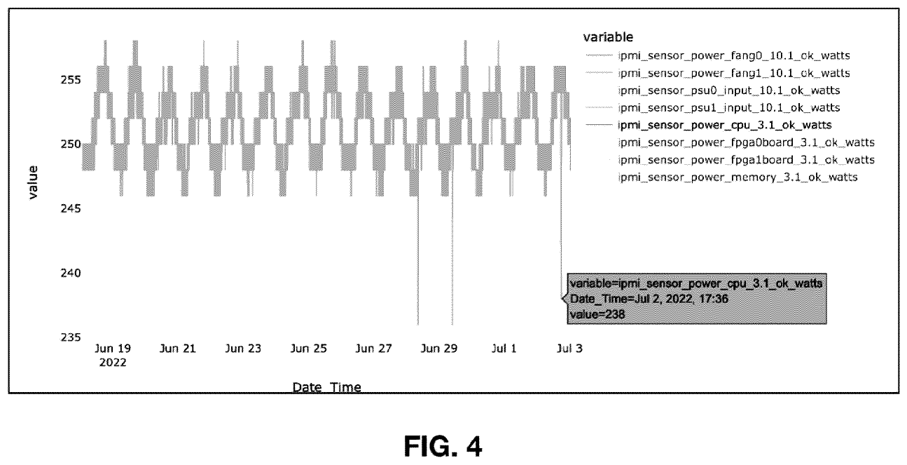

For example, referring to TABLE 6 and FIG. 4, a metric such as “ipmi_sensor”, in terms of CPU power over a defined period of time, is visually represented in a graph in FIG. 4.

Referring back to FIG. 2, the ML/NN model module can receive as input any of the of the one more metrics with respect to module 200. From those metrics, the ML/NN model of the disclosure described herein can use the metrics to generate embeddings (or any type of dimensionality reduction) in order to proactively predict and identify target network clusters and/or any specific target server/node within a network cluster that is best suited to execute and run a particular application, task, job, program, or operation. In addition, the ML/NN model may also use such metrics for training purposes. Here, the embeddings may be based on supervised learning, or models which can be trained from labeled or annotated datasets. Alternatively, the models may be trained via unsupervised learning, or where the models do not require labels. For example, in other embodiments, autoencoders may be used to train the model. In addition, the foregoing embeddings may also be used as input for other ML/NN models within the method and system of disclosure described herein to predict the best suited target server/node within a server cluster system. In other embodiments, the ML/NN model may assign certain higher or lower weights to certain servers/nodes to achieve improved probability with respect to network traffic and/or power requirements of those servers/nodes. Here, the output of the ML/NN model can be identification of the recommended or suggested target server cluster system and/or a target server/node within a server cluster system that is best suited to execute and/or run a particular application, task, job, program, or operation, such as any one or more of servers/nodes 222, 224, 226. For example, a best suited server/node may not necessarily be the first available server/node, but the server/node that historically can handle the processing needs of a particular application in the most energy efficient manner at a given time of day, time period, time range, and/or under certain conditions or events. Further, for example, the ML/NN model can predict whether that selected or identified server/node can consistently deliver the processing and/or power requirements (and bandwidth) for the application without CPU throttling.

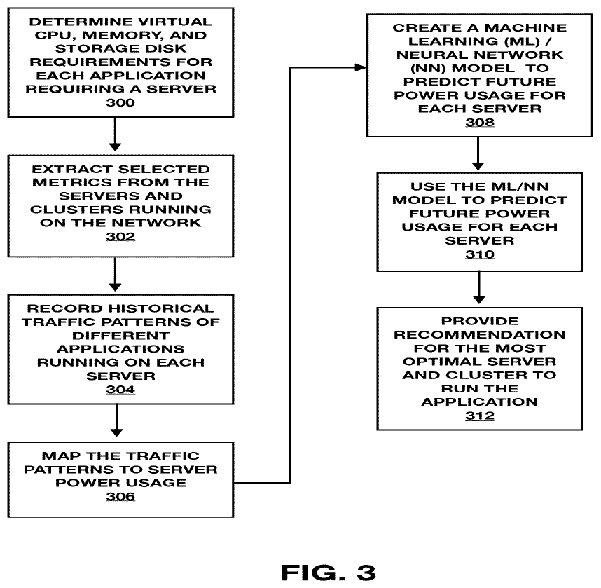

FIG. 3 illustrates a diagram for one exemplary embodiment of a method of operation for the dynamic resource management and allocation method and system of the disclosure described herein. Here, the process can begin at step 300, wherein the method and system can determine the various metrics or resource requirements for each application, job, task, operation, or program that requires a server/node to run, execute, and operate on, or each incoming or source application/task that is waiting (such as in a queue) to be executed on a target server/node. For example, such metrics can be virtual CPU, memory, and storage disk requirements for a particular application, or the metrics disclosed with respect to the metrics module 200 (FIG. 2). Next, at step 302, the determined application metrics can be extracted from the servers/nodes on each cluster running on the network, wherein the extracted metrics and the power usage are synchronized with time, whereby the mapping can identify the traffic pattern at a specified time. Next, at step 304, the method and system can obtain and record historical traffic patterns of various applications, tasks, jobs, programs, or operations on each server/node within each cluster. For example, the system can determine which server/nodes handle a particular application at a certain time of day or upon the triggering of some event and use such information as input in training the ML/NN model. Next, at step 306, the method and system can map the recorded traffic patterns for each application to the power usage and power consumption requirements of each server/node within the cluster. Here, the mapping may be based on power usage or power requirements of traffic patterns during a defined period of time.

Still referring to FIG. 3, at step 308, the process proceeds to create and generate an ML/NN model to predict power usage for each server/node, such as the energy requirements of each server/node at a given time of day. Next, at step 310, the method and system can use the output of the ML/NN model for predicting network traffic patterns, energy usage, and energy requirements to provide energy orchestration and resource allocation, namely, the automatic assigning or allocating of certain application, tasks, jobs, operations, or programs to certain target servers/nodes having the least power requirements and that can effectively execute and run the assigned application, task, job, operation, or program. For example, such future traffic predictions may be based on historical power consumption by the servers/nodes of a cluster. At step 312, the method and system can provide a recommendation/suggestion and/or identifying the most optimal server/node and/or cluster to run the application. In other embodiments, the method and system can automatically assign and allocate the most optimal server/node (with the least power requirements and can effectively run the application) to the particular application or the incoming/source application.

In other embodiments, any of the foregoing discussions may be represented on a graphical user interface (GUI), such as within a dashboard or portal. For example, a GUI may display the clusters and the individual servers/nodes within the clusters that are available and/or are running certain applications or tasks. In addition, a user may be able to visually see future energy usage and consumption based on prior known traffic patterns, and further provide the ability of network operators to better manage their clusters and servers/nodes during peak or low demand times and further better predict future network infrastructure needs to meet demands for certain traffic patterns.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method of allocating resources within a server cluster network, the method comprising:
determining one or more operational requirements with respect to a first task;
identifying a plurality of nodes within the server cluster network with respect to meeting the one or more operational requirements of the first task;
obtaining a traffic pattern with respect to each of the plurality of nodes with respect to one or more second tasks; and
identifying a first node from the plurality of nodes for executing the first task.

2. The method of claim 1, wherein the first task is comprised of at least one of: an application, program, job, or operation.

3. The method of claim 1, further comprising:
mapping the traffic patterns to a power requirement with respect to each of the plurality of nodes within the server cluster network.

4. The method of claim 3, further comprising:
generating a neural network model based on the mapped traffic patterns to the power requirement with respect to each of the plurality of nodes within the server cluster network.

5. The method of claim 4, wherein the neural network model is based on embeddings.

6. The method of claim 4, wherein the step of identifying the first node from the plurality of nodes for executing the first task is based on the generated neural network model.

7. The method of claim 6, wherein the step of identifying the first node from the plurality of nodes for executing the first task is further based on predicting future power consumption by each of the plurality of nodes.

8. The method of claim 7, further comprising:
assigning the first task to the identified first node.

9. The method of claim 7, further comprising:
determining one or more operational requirements with respect to a third task; and
identifying a second node from the plurality of nodes for executing the third task.

10. The method of claim 9, wherein the step of identifying the first node from the plurality of nodes for executing the first task is based on a neural network model.

11. An apparatus for allocating resources within a server cluster network, comprising:
a memory storage storing computer-executable instructions; and
a processor communicatively coupled to the memory storage, wherein the processor is con-figured to execute the computer-executable instructions and cause the apparatus to:
determine one or more operational requirements with respect to a first task;
identify a plurality of nodes within the server cluster network with respect to meeting the one or more operational requirements of the first task;
obtain a traffic pattern with respect to each of the plurality of nodes with respect to one or more second tasks; and
identify a first node from the plurality of nodes for executing the first task.

12. The apparatus of claim 11, wherein the first task is comprised of at least one of: an application, program, job, or operation.

13. The apparatus of claim 11, wherein the computer-executable instructions, when executed by the processor, further cause the apparatus to:
map the traffic patterns to a power requirement with respect to each of the plurality of nodes within the server cluster network.

14. The apparatus of claim 13, wherein the computer-executable instructions, when executed by the processor, further cause the apparatus to:
generate a neural network model based on the mapped traffic patterns to the power requirement with respect to each of the plurality of nodes within the server cluster network.

15. The apparatus of claim 14, wherein the neural network model is based on embeddings.

16. The apparatus of claim 14, wherein the step of identifying the first node from the plurality of nodes for executing the first task is based on the generated neural network model.

17. The apparatus of claim 16, wherein the step of identifying the first node from the plurality of nodes for executing the first task is further based on predicting future power consumption by each of the plurality of nodes.

18. The apparatus of claim 17, wherein the computer-executable instructions, when executed by the processor, further cause the apparatus to:
assign the first task to the identified first node.

19. The apparatus of claim 17, wherein the computer-executable instructions, when executed by the processor, further cause the apparatus to:
determine one or more operational requirements with respect to a second task; and
identify a second node from the plurality of nodes for executing the second task.

20. A non-transitory computer-readable medium comprising computer-executable instructions for allocating resources within a server cluster network by an apparatus, wherein the computer-executable instructions, when executed by at least one processor of the apparatus, cause the apparatus to:
determine one or more operational requirements with respect to a first task;
identify a plurality of nodes within the server cluster network with respect to meeting the one or more operational requirements of the first task;
obtain a traffic pattern with respect to each of the plurality of nodes with respect to one or more second tasks; and
identify a first node from the plurality of nodes for executing the first task.
